(19) United States
(12) Patent Application Publication
(10) Pub. No.: US 2026/0367886 A1
(43) Pub. Date: Nov. 19, 2026

(54) ISOLATION OF AUTOMATED SOFTWARE DEVELOPMENT WITH GENERATIVE RESPONSE ENGINES

(71) Applicant: OpenAI OpCo, LLC, San Francisco, CA (US)

(72) Inventors: Fotios Chantzis, San Francisco, CA (US); Channing Conger, San Francisco, CA (US); Joshua Ma, Burlingame, CA (US)

(21) Appl. No.: 19/324,967

(22) Filed: Sep. 10, 2025

Related U.S. Application Data
(60) Provisional application No. 63/806,537, filed on May 15, 2025.

(51) Int. Cl. G06F 8/35; G06F 8/36; G06F 8/71

(52) U.S. Cl. CPC G06F 8/35; G06F 8/36; G06F 8/71

(57) ABSTRACT

Systems and techniques are described herein for automating software development. For example, an apparatus is configured to: receive instructions to perform a software development task in natural language based on a repository; start a container having a default configuration, wherein the container includes a service for interacting with a machine learning model via an internal network interface and an external network interface for accessing the public network; after the container is started, retrieve packages associated identified by the repository to build a target identified by the repository; and after the packages are retrieved, disable the external network interface.

### CROSS REFERENCE TO RELATED APPLICATIONS

This application claims the benefit of U.S. provisional application number 63/806,537, filed on May 15, 2025, entitled AUTOMATED SOFTWARE DEVELOPMENT WITH GENERATIVE RESPONSE ENGINE, which is expressly incorporated by reference herein in its entirety.

### BACKGROUND

Generative response engines such as large language models represent a significant milestone in the field of artificial intelligence, revolutionizing computer-based natural language understanding and generation. Generative response engines, powered by advanced deep learning techniques, have demonstrated astonishing capabilities in tasks such as text generation, translation, summarization, and even code generation. Generative response engines can sift through vast amounts of text data, extract context, and provide coherent responses to a wide array of queries.

### BRIEF DESCRIPTION OF THE SEVERAL VIEWS OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings, and the claims.

FIG. 1 illustrates an example system supporting a generative response engine during inference operations in accordance with some aspects of the disclosure.

FIG. 2 is a conceptual block diagram of an automated software development system using a generative response engine in accordance with some aspects of the disclosure.

FIG. 3 is a timeline associated with a software development task using a generative response engine in accordance with some aspects of the disclosure.

FIG. 4A is a sequence diagram illustrating different modes of a software development task using a generative response engine in accordance with some aspects of the disclosure.

FIGS. 4B-4E illustrate various screens and conceptual diagrams of an automated software development system using a generative response engine in accordance with some aspects of the disclosure.

FIG. 5 is a sequence diagram illustrating various operations of a container to perform a software development task in an isolated environment using a generative response engine in accordance with some aspects of the disclosure.

FIG. 6 illustrates a flowchart of a software development task in an isolated environment using a generative response engine in accordance with some aspects of the disclosure.

FIG. 7 is a block diagram illustrating an example machine-learning platform in accordance with some aspects of the disclosure.

FIG. 8A, FIG. 8B, and FIG. 8C illustrate an example transformer architecture in accordance with some aspects of the disclosure.

FIG. 9 shows an example of a system for implementing some aspects of the present technology.

### DETAILED DESCRIPTION

Generative response engines such as large language models represent a significant milestone in the field of artificial intelligence, revolutionizing computer-based natural language understanding and generation. Generative response engines, powered by advanced deep learning techniques, have demonstrated astonishing capabilities in tasks such as text generation, translation, summarization, and even code generation.

Many generative response engines provide a conversational user interface powered by a chatbot whereby the user account interacts with the generative response engine through natural language conversation with the chatbot. Such a user interface provides an intuitive format to provide prompts or instructions to the generative response engine. In fact, the conversational user interface powered by the chatbot can be so effective that users can feel as if they are interacting with a person. Some user accounts find the generative response engine effective enough that they utilize the conversational user interface powered by the chatbot as they would an assistant.

One use of generative response engines is automated application development and software development functions to automate complex tasks, enhance productivity, and reduce manual errors. For example, generative response engines are driven by advanced artificial (AI) models and can interpret natural language specifications or high-level requirements and generate corresponding code, documentation, or configurations, which allows developers to focus more on architectural decisions and problem-solving rather than repetitive implementation details. As an example, a function that translates user stories into unit tests or skeleton code is important because it accelerates the development phase and also enforces consistency and test coverage from the outset. A generative engine can also automate the creation and maintenance of CI/CD pipelines by writing instructions (e.g., YAML or JSON) files for workflows, and generating server deployment scripts tailored to specific cloud environments. Additionally, generative response engines can automate tasks such as database schema migrations, application programming interface (API) endpoint scaffolding, and server provisioning to streamline operations and reduce friction between development and operations teams. Generative response engines can contribute to documentation, generate performance monitoring scripts, and produce security checks. Despite these advantages, generative response engines require thorough oversight, including human review of generated code, robust automated testing, and continuous feedback loops to ensure maintainability, security, and scalability.

In systems where an artificial intelligence (AI) model generates modifications to source code, it can be difficult to safely and efficiently promulgate those changes into the actual source repository. While the AI model may be capable of making valid edits in response to prompts or inputs, the act of committing those changes into a version-controlled environment (e.g., a remote Git repository) introduces operational and security complexities. In particular, existing implementations often rely on deterministic diffs produced within a container, which is then transferred to a clean environment to be applied and pushed. Ensuring that these diffs are accurate, complete, and applicable to the current state of the repository poses a significant challenge, especially when coordinating across asynchronous components and distributed services. Moreover, this workflow accounts for Git's handling of text and binary files, support for rollback or conflict resolution, and compatibility with existing CI/CD systems.

ML-generated code generation often occurs in temporary, sandboxed environments that differ materially from the live repository, similar to how online editors allow in-browser code manipulation without directly modifying the source repository. These ephemeral environments may operate on stale or incomplete clones of the repository, lack full dependency graphs, or omit contextual metadata such as CI/CD hooks and git history. As a result, the code that the AI model produces may be semantically incompatible with the actual repository state. This misalignment can lead to conflicts when applying patches, particularly in environments with fast-moving branches, binary assets, or tightly coupled module systems. Reconciliation between the sandbox and the repository uses careful version tracking and a process to revalidate code after it leaves the containerized environment.

Finally, allowing an AI model to write code with access to native filesystems or unrestricted network access introduces substantial security risks, including the potential for unintended side effects or malicious behavior. A compromised or misaligned model could execute unauthorized file operations, corrupt repositories, or exfiltrate credentials if granted access to local secrets or internet connectivity.

Systems and techniques are described herein for automating software development using an AI model configured to receive natural language instructions, generate source code modifications, and prepare a structured change proposal for integration into a version-controlled repository. In some implementations, the automating software development system obtains a diff generated by the AI model based on its completion of a software development task, and uses the diff to assemble a change proposal that includes the updated file content, repository tree structure, and commit lineage. The change proposal can then be rendered to a user via a front-end interface for inspection and approval prior to integration into the target branch of the repository. This approach supports structured automation of code editing tasks while preserving the visibility and traceability of changes made by the AI model.

In some aspects, the automating software development system spawns a containerized execution environment configured according to user-defined parameters. The container may include a preloaded development environment matching the repository's toolchain, package dependencies, or runtime configuration. Before providing the software development task to the AI model, the container's network interface is disabled, ensuring the model cannot exfiltrate data, download external packages, or otherwise perform unauthorized operations. This design supports secure, reproducible inference without introducing access to native filesystems or live repository credentials. Following task execution, the ML-generated changes are captured to produce a deterministic diff, which is extracted from the container for downstream processing. The network-disabled container thereby enforces strict boundaries between ML activity and the repository, eliminating many classes of risk associated with automated development systems.

To ensure accountability and correctness, the system includes a human-in-the-loop review mechanism whereby the diff and a summary of the model's proposed changes are displayed to a user. In some cases, a second container is spawned to apply and validate the proposed changes. This secondary container may clone the repository, apply the diff, and use programmatic interfaces such as GitHub's API to construct a manifest, create a commit, and open a pull request (PR). In some implementations, this process may include updates to text or binary files, or the addition and removal of repository files. By separating the environments where the model operates from those that execute repository updates, the system maintains strong security guarantees, supports enterprise deployment scenarios, and ensures that repository modifications are always mediated by human judgment and structured workflows.

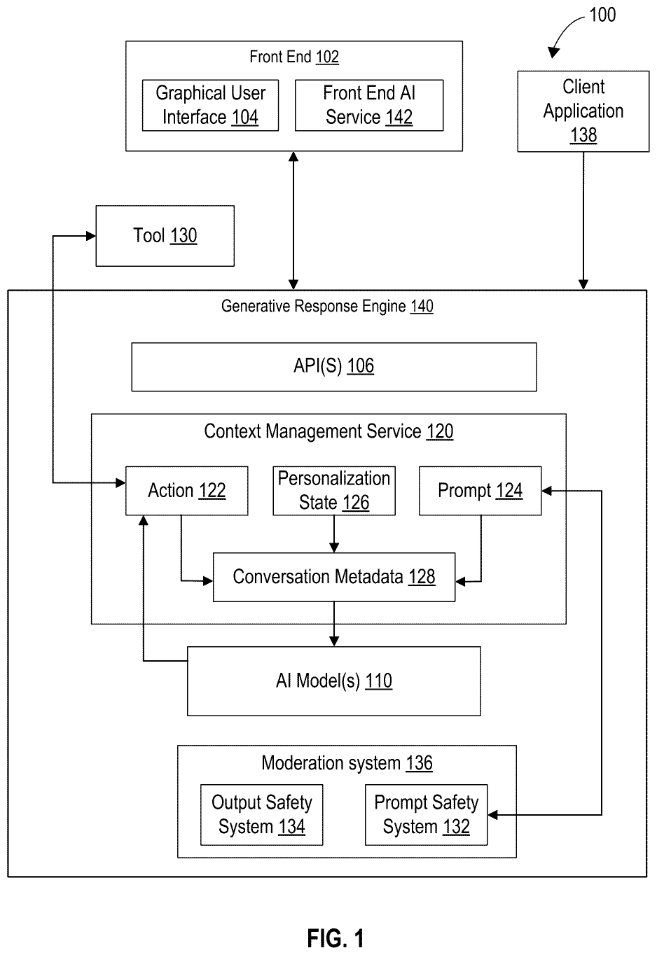

FIG. 1 illustrates an example AI assistant service supporting a generative response engine during inference operations in accordance with some aspects of the present technology. Although the example system depicts particular system components and an arrangement of such components, this depiction is to facilitate a discussion of the present technology and should not be considered limiting unless specified in the appended claims. For example, some components that are illustrated as separate can be combined with other components, and some components can be divided into separate components.

AI model(s) 110 are artificial intelligence (AI) models that can generate content in response to a prompt. The prompt can be from a human or a software entity (AI or applications, such as client application 138). The prompt is generally in natural language but could be in code, including binary. Some examples of AI model(s) 110 can include language models that generate language, such as CHATGPT, or other models, such as DALL-E or IMAGEGEN, which generate images, and SORA, which generates videos. CHATGPT, DALL-E, IMAGEGEN, and SORA are all provided by OPENAI, but AI model(s) 110 are not limited to AI provided by OPENAI. AI model(s) 110 can also be any type of generative AI and can include AI developed using various architectures such as diffusion models and transformers (e.g., autoregressive transformer architecture) and combinations of models. Some AI models are multi-modal models which can receive and output data in text, image, audio, etc.

In some instances, a language model, such as CHATGPT, can receive prompts to output images, video, code, applications, etc., which it can provide by interfacing with one or more other models, as will be addressed further herein.

AI model(s) 110 may be part of a generative response engine 140, where generative response engine 140 may include one or more components for supporting interaction with AI model(s) 110. Users can interact with generative response engine 140 through a front end 102 and applications can interact with generative response engine 140 through APIs 106. Front end 102 serves as the interface and intermediary between the user and generative response engine 140. It encompasses a graphical user interface 104 which may be used to provide input that facilitate communication with generative response engine 140 and AI model(s) 110. Generally, users interact through a graphical user interface 104 that often includes a conversational interface, and applications interact through the API 106, but this is not a requirement.

While some components are shown as being part of generative response engine 140 and some are outside of generative response engine 140, this is for illustration purposes and some components such as tool 130 might be part of generative response engine 140, and some components such as moderation system 136 might be outside of generative response engine 140. As used herein, generative response engine 140 encompasses deterministic services that are first-party services that prepare prompts to be sent to AI models, that are primitive level services that AI model(s) 110 can utilize to generate a response to a prompt. Services that are outside of generative response engine 140 are logically separate. For example, front end 102 might be a first-party front end (provided by the same party that provides generative response engine 140) but front end 102 is used to interface with generative response engine 140 rather than aid in developing a response to a prompt.

Some components of generative response engine 140 might be executed by computing programming units (CPU), and some components might be executed by graphical processing units (e.g., AI model(s) 110).

In some embodiments, client application 138 might provide a graphical user interface that is custom to client application 138 or can display graphical user interface 104 provided by generative response engine 140 provider.

Graphical user interface 104 is the platform through which users interact with the generative response engine 140. It can be a web-based chat window, an application, or any interface that supports data input and output. Graphical user interface 104 facilitates a conversation between the user and AI model(s) 110, as the user provides prompts in graphical user interface 104 to which AI model(s) 110 respond, and generative response engine 140 presents those responses in graphical user interface 104. In some aspects, graphical user interface 104 presents a conversational interface, which has attributes of a conversation thread between a user account and AI model(s) 110.

Graphical user interface 104 is configured to perform input handling and output presentation. The type of inputs that can be received can be relative to the specifics of generative response engine 140 and/or AI model(s) 110. For example, a language model is generally configured to accept text, but when the AI model is a multi-modal AI model, front end 102 can accept voice and images/video.

In some aspects, front end 102 can be a layer to accept any inputs, provide the inputs to generative response engine 140, receive outputs from generative response engine 140 and display the outputs. Graphical user interface 104 can accept any input types as part of the prompt, and front end AI service 142 can determine which AI model or collection of AI models are best suited to respond to the prompt. Front end AI service 142 can be one or more AI models that can be trained to determine which AI model should be used to respond to a prompt, and in some examples, can be used to improve prompts or provide additional configuration details, such as how long a reasoning model should spend processing a prompt. In general, front end AI service 142 can support functions of graphical user interface 104 by performing interference operations before a prompt is sent to generative response engine 140. Generally graphical user interface 104 is present on a client device, while front end AI service 142 might be present on the same client device or on a server in a data center.

Graphical user interface 104 is also configured to maintain the context of the conversation, which allows for coherent and relevant responses. For example, graphical user interface 104 is responsible for providing the conversation thread and other relevant context accessible to the front end 102 to the AI models along with the specific prompt. In an example, a conversation between the user account and the AI model(s) 110 can have taken several turns (prompt, response, prompt, response, etc.). When the user account provides a further prompt, the graphical user interface 104 can provide that prompt to AI model(s) 110 in the context of the entire conversation.

In another example, graphical user interface 104 might be configured to provide a system prompt along with a user-provided prompt. A system prompt is hidden from the user account and is used to set the behavior and guidelines for the AI model. The system prompt can be used to define the AI's persona, style, and constraints. There can be levels of system prompts. A highest level of a system prompt might be provided by the AI model(s) 110 provider and is meant to establish policies for the behavior of AI model(s) 110. This highest level of system prompt should be prohibited from being edited. A customization system prompt can be used to customize the behavior of the AI model and is often provided through an API call, or provided by a user account when creating a customized version of AI model(s) 110. A still lower level of system prompt might include hidden information about a task. This can include chain-of-thought from a reasoning model, or context about an application that AI model(s) 110 is working with to complete a task. Accordingly, graphical user interface 104 does not display all of the output of the AI model.

Graphical user interface 104 is also configured to display the responses from the AI model, which might include text, code snippets, images, or interactive elements.

In some aspects, AI model(s) 110 can provide instructions to front end 102 that instruct graphical user interface 104 about how to display some of the output from the AI model. For example, the AI model and/or generative response engine can direct graphical user interface 104 to present code in a code-specific format, or to present interactive graphics, or static images. In other examples, the AI model and/or generative response engine can direct graphical user interface 104 to present an interactive document editor where graphical user interface 104 can be presented with the document editor so that the user account and the AI model can collaborate on the document.

In some aspects, AI model(s) 110 can provide instructions to personalization state 126 to record facts in a personalization notepad. Personalization state 126 can store information received directly from the user account or inferred from prompts provided by the user account, and can be used to provide context to the AI model such that output is personalized for the user account. In some examples, front end 102 can be configured to notify the user account that a memory was created. Personalization state 126 can also include summaries of past conversation threads between the user account and the generative response engine 140, and/or a searchable index of past conversation threads. In this way, personalization state 126 aid generative response engine 140 and/or AI model(s) 110 to learn specific facts about a user account and recall past interactions. The past interactions can be used to guide future responses by generative response engine 140 and/or AI model(s) 110 such that generative response engine 140 and/or AI model(s) 110 becomes personalized to a particular user account.

Generative response engine 140 can provide one or more application programming interfaces (API(s)) 106. APIs enable developers to integrate the AI model's capabilities into external applications and services. APIs 106 provide programmatic access to generative response engine 140, allowing for customized interactions and functionalities. While APIs 106 are shown as part of generative response engine 140, in some examples, APIs 106 are part of front end 102. API 106 can refer to points of access to AI model(s) 110. In some examples, API 106 endpoints are located at context management service 120.

APIs 106 can accept structured requests containing prompts, context, and configuration parameters. For example, an API can be used to provide prompts and divide the prompt into system prompts and user prompts. In some aspects, APIs 106 can provide specific inputs for which AI model(s) 110 are configured to respond with a specific behavior. For example, an API can be used to specify an output in a particular format or structured output. For example, in the chat completion API, the API call can specify parameters for the output, such as the max length for the desired output, and specify aspects of the tone of the language used in the response. The output can also be structured output and in a data interchange format such as JavaScript object notation (JSON). For example, the input query may include a schema that identifies a specific output structure. Some common APIs are for participating in a conversation (Chat Completion API), for providing a single response (Completion API), for converting text into embeddings (Embeddings API), etc. The API can also be used to indicate specific decision boundaries that AI model(s) 110 might be trained to interpret. For example, the moderation API can take advantage of AI assistant service 100′s content moderation decision-making. In the case of the moderation API and others, the API might give access to services other than the AI model. For example, the moderation API might be an interface to moderation system 136, addressed below.

Some other common APIs include the Fine-Tuning API, which allows developers to customize AI model(s) 110 of generative response engine 140 using their own datasets; the Audio and Speech APIs, which cause AI model(s) 110 to output speech or audio; and the Image Generation API, which causes AI model(s) 110 to output images (which may request operations of other models).

There can also be APIs that direct AI model(s) 110 and/or generative response engine 140 to interface with other applications or other generative AI engines. In such cases, the specific application or AI engine might be specified, or AI model(s) 110 might be allowed to choose another application of generative response engine 140 to use in response to a prompt.

As described herein, a Responses API can be an improved API for interacting with AI model(s) 110. Responses API can take as a parameter a response ID, which can be used to return AI model(s) 110 to a state that the model was in at a particular response, thereby allowing a user account or developer to recall a previous context without having to re-prompt AI model(s) 110 or having to replicate a previous series of prompts. Further, Responses API can facilitate function/tool chaining to enable execution of operations requiring several function/tool calls without the added overhead of responding to an API caller to call the function or tool. Instead, deterministic code associated with the API can be directed to call functions or tools (including other AI models) on behalf of the AI model, and return data resulting from the function or tool call to the AI model.

In short, graphical user interface 104 and APIs 106 can be used to provide prompts to AI model(s) 110 of generative response engine 140. Prompts are sometimes differentiated into prompt types. For example, a system prompt can be a hidden prompt that sets the behavior and guidelines for the generative response engine. A user prompt is the explicit input provided by the user, which may include questions, commands, or information.

Generative response engine 140 may also include a context management service 120. The function of context management service 120 is to manage and organize the flow of data among key subsystems, enabling AI model(s) 110 to generate responses that are contextually relevant, accurate, and enriched with additional information as required.

Action 122 facilitates auxiliary tasks that extend beyond basic text generation. In some aspects, action 122 can be actions that correspond to an API 106. In some aspects, action 122 can be agentic actions that AI model(s) 110 decide to take to carry out a user's intent as described in the prompt. For example, an action can be to call tool 130 or even other AI model(s) 110. Tools 130 can include internet browsers, editors such as code editors, other AI tools, etc. While tools are shown outside of generative response engine 140, some tools might be part of generative response engine 140 and some tools might be external tools.

Prompt 124 is the request or command provided by the user account through front end 102. In some aspects, prompt 124 can be further supplemented by a system prompt and other information that might be included by graphical user interface 104 or API 106 or associated with a custom AI model. In some aspects, prompt 124 can be modified or enhanced by AI model(s) 110 as addressed further below. Additionally, as the user account provides prompts and AI model(s) 110 provide responses, a conversation thread forms. As the user account provides a new prompt, this is appended to the overall conversation and added to prompt 124. Thus, a user account might think of a first user-provided message as a first prompt and a second user-provided message as a second prompt, and so on, but prompt 124 as perceived by AI model(s) 110 can include a thread of user-provided messages and responses from AI model(s) 110 in a multi-turn conversation. The actors in the conversation thread can be labeled so that AI model(s) 110 can review the turns of the conversation. Generally, prompt 124 will include an entire conversation thread, but in some instances, prompt 124 may be shortened if it exceeds a maximum accepted length (generally measured by a number of tokens).

In some examples, context management service 120 can also route prompts and response through moderation system 136. In some aspects, prompts are provided to prompt safety system 132 before being provided to AI model(s) 110. Prompt safety system 132 is configured to use one or more techniques to evaluate prompts to ensure a prompt is not requesting AI model(s) 110 to generate moderated content. In some aspects, prompt safety system 132 can utilize text pattern matching, classifiers, and/or other AI techniques.

Since prompts can evolve over time through the course of a conversation, consisting of prompts and responses, prompts can be repeatedly evaluated at each turn in the conversation.

Personalization state 126 can facilitate continuity and personalization in conversations. It allows the system to maintain user-specific context, preferences, or details that may inform future interactions. Personalization state 126 can include a memory file of persisted data from previous interactions or sessions that provide background information to maintain continuity. In some aspects, information can be recorded to personalization state 126 at the instruction of AI model(s) 110 when AI model(s) 110 identify a fact or data that it determines should be saved in memory because the fact and/or data might be useful in later conversations or sessions. In some aspects, personalization state 126 can also include synthesized concepts extracted from past conversation threads, and personalization state 126 can also encompass the ability of AI model(s) 110 to search through past interactions to find relevant information to a current conversation thread.

Conversation metadata 128 can aggregate data points relevant to the conversation, including user prompt 124, action 122, and personalization state 126. This consolidated information package serves as the input for AI model(s) 110. Conversation metadata 128 can label parts of a prompt as user-provided, AI model-provided, a system prompt, personalization state 126, data from action 122 or tool 130 (addressed below).

AI model(s) 110 are the core engines that process inputs (from context management service 120) and generate outputs. In some aspects, AI model(s) 110 may be a generative transformer, or autoregressive transformer, but could use other architectures. In some examples, the transformer is multi-modal transformer that can use audio tokens (or embeddings thereof), visual tokens (or embeddings thereof), and language (or embeddings thereof) as needed.

A core feature of AI model(s) 110 is to generate content in response to prompts. The prompt can be from client application 138 provided via graphical user interface 104. AI model(s) 110 can be configured to receive inputs via APIs 106 that provide guidance on a desired output. AI model(s) 110 can analyze the input and identify relevant patterns and associations in the data, and generate a sequence of tokens that are predicted as the most likely continuation of the input. AI model(s) 110 generate responses by sampling from the probability distribution of possible tokens, guided by the patterns observed during its training. Two features of the autoregressive transformer that result in this functionality are that the autoregressive transformer might use the decoder part of the transformer architecture and that it utilizes self-attention. By using the decoder part of the transformer architecture, the transformer focuses on predicting the tokens given the previous context tokens. The self-attention mechanism captures long-range dependencies amongst tokens, allowing it to generate contextually relevant responses (in text, audio, images, and video).

In some aspects, AI model(s) 110 can generate multiple possible responses before presenting the final one. AI model(s) 110 can generate multiple responses based on the input, and these responses are variations that AI model(s) 110 consider potentially relevant and coherent.

In some aspects, AI model(s) 110 can evaluate generated responses based on certain criteria. These criteria can include relevance to the prompt, coherence, fluency, and sometimes adherence to specific guidelines or rules, depending on the application. Based on this evaluation, AI model(s) 110 can select the most appropriate response. This selection is typically the one that scores highest on the set criteria, balancing factors like relevance, informativeness, coherence, and content moderation instructions/training.

In some aspects, an instruction provided by an API 106, a system prompt, or a decision made by AI model(s) 110 can cause AI model(s) 110 to interpret a prompt and re-write it or improve the prompt for a desired purpose. For example, AI model(s) 110 can determine to take a prompt to make a picture and enhance the prompt to yield a better picture. In these instances, AI model(s) 110 can generate their own prompts, which can be provided to tool 130 or provided to AI model(s) 110 to yield a better output response than the original prompt might have.

AI model(s) 110 can also do more than generate content in response to a prompt. In some aspects, AI model(s) 110 can use decision boundaries to determine the appropriate course of action based on the prompt. In some examples, a decision boundary might be used to cause the AI model to recognize that it is being asked to provide a response in a particular format such that the AI model will generate its response constrained by the particular format. In some examples, a decision boundary can cause the model to refuse to generate a responsive output if the decision is that the responsive output would violate a moderation policy. In some examples, the decision boundary might cause the AI model to recognize that it interfaces with another AI model or application to respond to the prompt. For example, when the AI model is a language model, it might recognize that it is being asked to output an image, and therefore, it interfaces with a model that can output images to provide a response to the prompt. In another example, the prompt might request a search of the Internet before responding. The AI model can use a decision boundary to recognize that it should conduct a search of the Internet and use the results of that search in responding to the prompt. In another example, the prompt might request that the AI model take an agentic action on behalf of the user by interacting with a third-party service (e.g., book a reservation for me at . . . ), and the AI model can use a decision boundary to recognize that it should plan steps to locate the third-party service, contact the third-party service, and interact with the third-party service to complete the task and then report back to the user that the action has been completed.

When AI model(s) 110 determine to take an agentic action on behalf of the user or to call a tool to aid in providing a quality response to the user account, AI model(s) 110 might call a tool 130 or cause an action 122 to be performed. As indicated above, tools 130 can include internet browsers, editors such as code editors, other AI tools etc. Actions 122 are actions that AI model(s) 110 can cause to be performed, perhaps using tool 130. As used herein actions 122 should be considered to cover a broad array of actions that AI model(s) 110 can perform with or without tools 130. Tools 130 are considered to cover a wide variety of services and software that encompass tools such as a computer operating system such that AI model(s) 110 can control the computer operating system on the user's behalf, to robotic actuators, to search browsers and specific applications.

Additionally, AI model(s) 110 can also generate portions of responses that are not displayed to the user. For example, AI model(s) 110 can direct front end 102 to provide specific behaviors, such as directions for how to present the response from AI model(s) 110 to the user account. In another example, AI model(s) 110 can provide response portions dictated by APIs 106, where portions of the response to the API might be for the consumption of the calling application but not for presentation to the end user. In another example, some AI model(s) 110 are reasoning models, which are AI model(s) 110 that are configured to output a raw chain-of-thought before preparing a final response to a prompt. The raw chain-of-thought might not be presented to a user account or application calling an API. Instead, another AI model might summarize the raw chain-of-thought into a more consumable and useful output for the user account or application.

In some aspects, the output of the AI model can be further analyzed by output safety system 134. While AI model(s) 110 can perform some of their own moderation, there can be instances where it is beneficial to have another service review outputs for compliance with a moderation policy. The use of dashed lines in FIG. 1 differentiates a path using output safety system 134 and not using output safety system 134.

As used herein, the present description may refer to the generative response engine or AI model(s) making a determination or reasoning prior to providing a response to a prompt. Determining can refer to a process by which an AI model outputs a response that provides a conclusion. In an example, an AI model can perform an inference operation to output a sequence of tokens, which output provides a determination. In such an example, the AI model might not have made any decision other than to sample particular tokens to provide an output, yet the response from the AI model might be a statement of determination. In another example, AI models can be trained to make particular determinations. In such examples, the AI model can be trained to make a decision, such as to cross a decision boundary to take an agentic action or to call a tool, etc.

Reasoning refers to simulating logical processes to draw conclusions or perform tasks based on provided inputs and learned information. Although the AI model might lack true understanding, the AI model uses pattern recognition and linguistic associations to emulate reasoning by linking related concepts and predicting outcomes. As used herein, the term reasoning by an AI model refers to the process performed by AI models known as reasoning models.

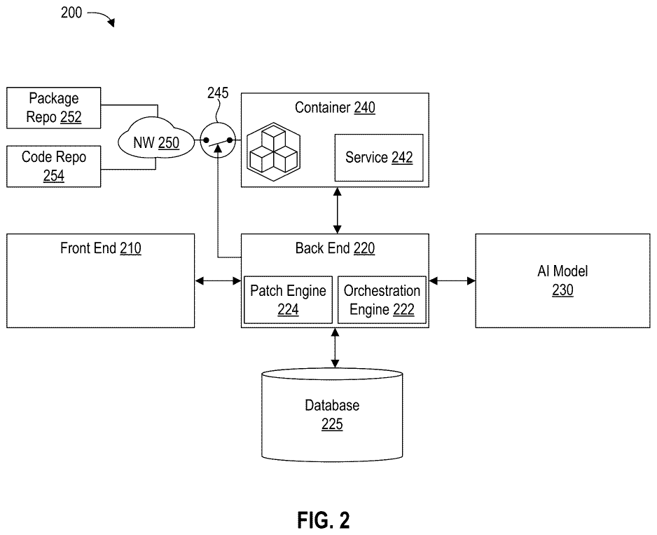

FIG. 2 is a conceptual block diagram of an automated software development system 200 using a generative response engine in accordance with some aspects of the disclosure. In some aspects, automated software development system 200 includes components of a generative response engine such as a front end 210 (e.g., front end 102), back end 220, and AI model 230 (e.g., a transformer-based model, etc.).

In some aspects, AI model 230 is a foundation model, which is large-scale, pre-trained model built on vast and diverse datasets, designed to generalize across a wide range of downstream tasks such as language understanding, code generation, image analysis, and more. Foundation models leverage transfer learning to adapt efficiently to new problems with minimal additional training. An example of a foundation model is a reasoning foundation model that uses chain-of-thought reasoning in which the model generates intermediate logical steps to arrive at a final answer. This process mimics human problem-solving by structuring the reasoning path, which improves both the accuracy and interpretability of the model's outputs. In some cases, the foundation model can be fine-tuned for specific tasks, such as software development, and the model can be pruned to reduce weights and its ability to perform general-purpose reasoning, thereby using fewer computational resources and improving efficiency for targeted applications.

In some aspects, front end 210 can be a client application that is presented at an edge device and can be configured in various forms such as a native application, a cross-platform application using a webview renderer (e.g., Electron, etc.), or a web browser instrumented application with instructions (e.g., a JavaScript bundle such as React or WebAssembly bytecode, etc.). In some cases, client application 212 can be retrieved from cloud computing service 204 (e.g., as a JavaScript bundle) or may be rendered via cloud computing service 204 via different techniques (e.g., server-side rendering, partial hydration, etc.).

The back end 220 provides an interface for front end 210 to interact with various components on a server or cloud. For example, back end 220 includes various services such as database 225, inspection services to analyze the safety of prompts, and interface with AI model 230. Back end 220 includes orchestration engine 222 and patch engine 224 to implement software development services. Orchestration engine 222 is configured to receive instructions from front end 210 and spawn a container 240 including a development environment. In some aspects, edge device (e.g., controlled by a user) can configure various aspects such as an execution environment. The execution environment includes a base system (e.g., a Linux distribution) and can be instructions to build the base environment (e.g., a docker file). The execution environment can also include additional instructions to instrument the development environment with various services, packages, package managers, servers, configurations, SDKs, and so forth. For example, the execution environment can include instructions to include a package manager (e.g., pip for Python, cargo for rust, and npm for JavaScript, etc.) as well as various dependencies. As an example, a dependency can be a development tool (e.g., a linter for checking for errors before building, a prettier to consistently format code, etc.), a library for interacting with a database, a framework (e.g., React, etc.), a development package, and so forth.

Orchestration engine 222 receives various information from front end 210 including the execution environment and spawns container 240 including the development environment (not shown) and service 242.

In some aspects, container 240 has a lifecycle that is suitable for network applications. In particular, an instance of a container 240 is created, started, optionally paused, stopped, and eventually removed. At creation (e.g., docker create or docker run), container 240 is built from a specified image and includes an isolated environment, which contains the filesystem, environment variables, entrypoint, and network settings. When started, container 240 runs a defined process (e.g., in the dockerfile) with limited access to the host system. Container 240 is a sealed environment and can be accessed through services installed within the dockerfile. For example, access to container 240 (e.g., files, APIs, or other functionality) is provided via services installed and configured at build time (e.g., in the docker configuration or the dockerfile). After container 240 is executed, container 240 can be accessed via the defined services, and there is implicit access to its contents. Once the process ends, container 240 stops. Any changes made within container 240 (e.g., to the filesystem) are generally ephemeral and are lost when the container is stopped or removed.

In some aspects, container 240 may include service 242 that is configured to interact with AI model 230. For example, AI model 230 may be executing in specialized hardware for floating point operations (e.g., a graphical processing unit (GPU), a multiply accumulate (MAC) unit, etc.). The container 240 can expose a port to allow service 242 to interact with AI model 230 and perform functions associated with AI model 230. In some cases, various actions by AI model 230 can compromise the actions performed within container 240, such as attempting a denial of service attack, posting malicious social media content, and so forth. Even though container 240 is an isolated environment, it can be sealed from external access, and internal commands may be permitted. For example, container 240 may execute shell commands (e.g., curl, etc.) or other applications (e.g., ping, etc.) that can be accessed for various malicious purposes.

In some aspects, switch 245 is configured to permit or deny access to external network 250 by container 240. Switch 245 may be a logical network interface of container 240, and switch 245 is illustrated to show that back end 220 controls whether container 240 can access external network 250 (not the internal network). In some aspects, switch 245 can be enabled for an initialization period associated with configuring the container. In this case, container 240 can access network 250 to access package repository 252 during an initialization period associated with container 240. Package repository 252 can include various software packages, container images, and other components to generate and configure container 240. In some aspects, orchestration engine 222 is also configured to cause container 240 to access code repository 254 to locally clone a public or private repository. For example, orchestration engine 222 can access GITHUB (either using a public interface or a private repository based on a stored secret of the user) and retrieve and store code repository 254 within container 240.

Switch 245 may disable access to network 250 after all code and packages are installed in container 240 and the initialization period ends. For example, switch 245 is enabled before AI model 230 is provided access to service 242 of container 240 and is disabled when AI model 230 has access to service 242 of container 240. In this case, container 240 is unable to access external network 250 and the data, packages, code, and other content installed on container 240 can be accessed via an internal interface (e.g., a network file system service). In this way, container 240 cannot perform any malicious actions outside of its environment and any harmful activities are restricted to its environment. In some aspects, switch 245 can be configured using an internal interface (e.g., iptables in a Linux container) or an external interface (e.g., via a control plane associated with a container service).

In some aspects, switch 245 can be configured based on user control. For example, a user, as part of a project or an execution environment, may elect to enable limited or unlimited network access. For example, the user may configured container 240 to control the scope of network access via a configuration to restrict access to particular domains and protocols. For example, a user repository may be focused on implementing a new service based on an API (e.g., weather. acme. com), and internal and external network access can be limited to network traffic to and from that fully qualified domain name. In other examples, network access can be time limited based on an external request to an external service, requiring a response within a duration (e.g., 5 seconds). In some cases, container 240 could include default configurations that identify advertent or inadvertent misbehavior, such as a loop that continues to execute an identical network request based on an improper configuration. Table 1 below illustrates an example of rules that can be applied to a firewall of container 240, such as a command-line utility iptables, which configures the packet filtering rules of the Linux kernel firewall

TABLE 1
# Default policy: drop everything
iptables −P INPUT DROP
iptables −P OUTPUT DROP
iptables −P FORWARD DROP
# Allow loopback for local apps
iptables −A INPUT −i lo −j ACCEPT
iptables −A OUTPUT −o lo −j ACCEPT
# Allow incoming established connections (like replies)
iptables −A INPUT −m state −−state ESTABLISHED,RELATED −j ACCEPT
# Allow outgoing DNS (UDP port 53) to your resolver
iptables −A OUTPUT −p udp −−dport 53 −j ACCEPT
# Resolve acme.com to IP(s)
# (Always resolve outside iptables, e.g., use ‘dig‘ or ‘nslookup‘)
ACME_IP=$(dig +short acme.com | head −n 1)
# Allow outgoing traffic to acme.com IP on any port
iptables −A OUTPUT −d $ACME_IP −j ACCEPT

AI model 230 is configured to interact with service 242 of container 240 to generate code changes and other modifications within container 240 based on a natural language instruction. For example, service 242 can provide terminal access to AI model 230 (e.g., STDIN, STDOUT, STDERR) and allow AI model 230 to use the command line interface (CLI) to interact, read, and modify the copy of local code repository (e.g., cloned from code repository 254), run tests, and other developer functions. The service 242 can also include an interface that exposes an API to make modifications via commands that AI model 230 is trained with to provide discrete functions associated with a software development task. For example, AI model 230 can access a local GITHUB repository (e.g., the locally cloned repository within container 240) to create, read, update, and delete code files using an API. The AI model 230 behaves like an autonomous developer and reads code context, reasons about functionality or bugs, and produces inline edits, new code, and removes code as needed. The AI model 230 is able to perceive the entire context of the project while isolating changes to container 240.

Conventional automated development techniques either use direct access to a live system to directly modify files without network isolation (e.g., within a local development environment) and risk potential malicious behavior, or an incomplete understanding of the environment based on modification of a part of a repository within a web-based environment. For example, the local configuration can include various settings (e.g., a linter, a configuration file, etc.) and copying the code from a web-based front end may require additional modification to match the local development environment. For example, if the noImplicitAny flag is set to false in a local typescript configuration file and the code has implicit any return values, copying the changes from a web-based environment can create additional errors within the copied instructions based on differences in the local development environment and the web-based front end.

In some aspects, AI model 230 is configured to execute in a different hardware environment and can access service 242 to interact with the software development environment. For example, AI model 230 is typically executed at inference (e.g., at runtime) on specialized hardware, such as GPUs or custom accelerators, such as tensor processing units (TPUs), that are configured for large-scale matrix math. ML inference and training involve massive parallel floating-point computations (e.g., matrix multiplications) that are faster on GPU hardware. For example, AI model 230 may require access to high-throughput memory (e.g., high bandwidth memory (HBM)) and parallel processing cores that are not available in conventional CPU architectures.

Multiple instances of automated software development system 200 may execute in parallel to handle different tasks. For example, a first instance of automated software development system 200 can be adding database integration, a second instance of automated software development system 200 can be adding authentication, and a third instance can be adding a new feature.

After the task by AI model 230 is completed, orchestration engine 222 is configured to use service 242 to extract the development data associated with the task, which includes modifications, commands, changes, and any events that occurred within container 240 while being controlled by AI model 230. Orchestration engine 222 stores the development data in database 225.

Patch engine 224 is configured to access the development data extracted by orchestration engine 222 and generate a change proposal associated with code repository 254. For example, patch engine 224 can run commands to deterministically produce a diff of all the changes made within the development data. In some cases, patch engine 224 may be configured to receive the development data and identify the various changes (e.g., using a deterministic diff) and store the modifications in database 225.

In some aspects, AI model 230 can generate and output the diff to database 225. For example, AI model 230 can call a deterministic function. In some cases, AI model 230 may be able to reason and generate the diff during inference. In some cases, AI model 230 can also review the changes to validate that its reasoning corresponds to the generated instructions.

Patch engine 224 (or AI model 230) generates a diff that identifies a representation of changes (e.g., insertions, deletions) in a particular file. AI model 230 can be configured to output structured information using various techniques, such as a data validation function or library (e.g., zod) that validates data types that cross system boundaries. Table 2 below illustrates a diff command of two files (e.g.,. /a/hello. txt and. /b/hello. txt) and a corresponding output format that identifies line-based changes (e.g., @@−1 +1,2 @@ indicates to remove a line, and add two, followed by the lines to remove based on a leading “−” lines to add based on a leading “+”).

TABLE 2

diff −−git a/hello.txt b/hello.txt
index e69de29..a3c1234 100644
−−− a/hello.txt
+++ b/hello.txt
@@ −1 +1,2 @@
−Hello world
+Hello world!
+Goodbye world.

In some aspects, automated software development system 200 is configured to generate a change proposal associated with code repository 254. For security purposes, automated software development system 200 may not be configured to directly access code repository 254 and can generate the change proposal for the user's review. The change proposal also includes additional information that can be used to generate all changes based on a state of code repository 254. For example, the change proposal can include a source branch containing proposed changes, a target branch where the changes are intended to be merged, a commit history that outlines the modifications, a diff showing line-by-line changes to files, and optional metadata such as a title, description, reviewers, and discussion comments for code review and collaboration. For example, a commit is a snapshot of a repository at a specific point and links to a tree of that snapshot. The commit includes a pointer to a tree object (e.g. a tree of files), a list of parent commits (for history), and other metadata (e.g. author, timestamp, commit message, etc.). The commit points to the new tree and previous commit and allows a graph to be constructed to identify changes to be made out of order.

In some aspects, the change proposal or at least parts of the change proposal and generated and provided to back end 220 based on user input. For example, front end 210 can display various options associated with the change proposal, such as the ability to view and generate a pull request. Based on the user input, back end 220 accesses database 225 and generates the change proposal.

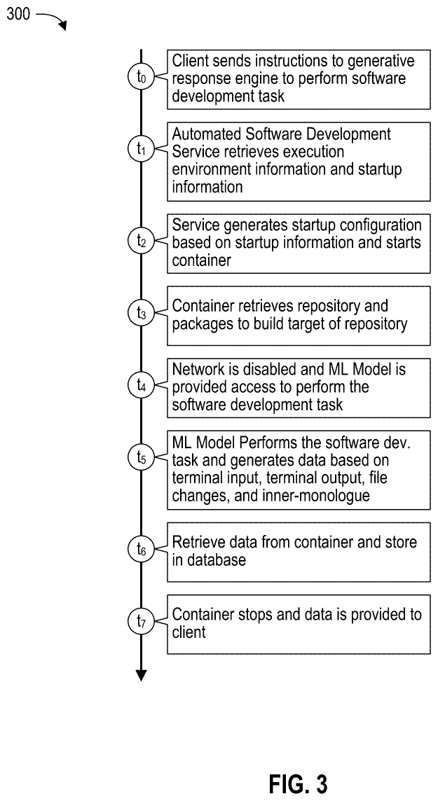

FIG. 3 is a timeline 300 associated with a software development task using a generative response engine in accordance with some aspects of the disclosure. In some aspects, an automated software development system is described that may include various aspects (e.g., an agent operating on a back end, a container including and development environment, etc.). An AI model (e.g., an LLM, etc.) can be configured to access the container to perform various software development functions.

At time t₀, a client device first sends instructions to a generative response engine to perform a software development task. For example, the client device may be executing or displaying a front end (e.g., the front end 102) for interacting with a generative response engine (e.g., the generative response engine 140). The front end may include an option to select a repository, which can either be public or private, and then perform a corresponding task. Non-limiting examples of tasks include a task to generate code based on the instruction or to query the generative response engine regarding the code or a change applied to the code. In some aspects, the instructions can include information associated with a public or private repository that can be accessed via a network connection. In some cases, the user can provide a bundle (e.g., a zip file including a repository and package information that identifies external packages in a repository).

At time t₁, the back end (e.g., the orchestration engine 222) of the software automated development system using the generative response engine is configured to receive the instructions and retrieve execution environment information and user startup information associated with a user. For example, the execution environment can include information associated with a development environment, such as a package manager, a testing library, and other preferences associated with a user. The user startup information can also include environment variables and user secrets (e.g., API keys and other authentication credentials). The user startup information can also include specialized information such as a script to validate the development environment and other information. For example, the scripts can validate that the user secrets are successfully loaded.

At time t₂, the back end is configured to generate system startup information to inject into the container. In some aspects, the back end may include a default configuration that initializes various services such as a network file system, a server configured to interact with the generative response engine, etc. The system startup information can also be modified to include the user startup configuration, and can then be injected into the container during a startup command. For example, Table 3 illustrates a docker run that starts a container based on an image (e.g., aSWEdefaultImage), injects a startup script (startup. sh), and executes the startup script. In this example, the--rm flag automatically removes the container when it stops.

TABLE 3

docker run −−rm −it \
−−name aSWEdefaultImage \
−−network=host \
−v “$PWD/startup.sh”:/entrypoint.sh:ro \
aSWEdefaultImage \
zsh /entrypoint.sh

The entry point (entrypoint.sh) of the container is the last command that executes, and when the entry point is complete, the container is configured to stop. In some aspects, the entry point can include various services such as a network server that executes until an external command is provided, a network file system, a terminal emulator, etc.

The automated software development system is configured to start the container based on the combined startup script. For example, a command corresponding to the docker run command in Table 3 is configured to start the container. According to some aspects, the startup of a Docker container differs from that of a conventional virtual machine (VM) image and omits parts of the boot stage such as BIOS/UEFI initialization, a bootloader, and kernel loading. The container shares the host system's kernel and launches directly into a specified user-space process, such as a shell script or server executable. Container images generally contain only the minimal set of libraries and binaries required to run the target application or library and avoid the need for a full guest operating system to enable more efficient use of storage and memory.

Upon container startup, a system startup script is executed. As noted above, the startup script may be dynamically modified or extended to include user-specific configuration scripts or secrets, which are injected into the container environment at runtime. These user-specific scripts may configure services, set environment variables, or provide access credentials required by the containerized application.

At time t₃, the automated software development system is configured to retrieve (e.g., clone) a repository associated with the instructions. In some aspects, the startup script can be modified to include instructions with a repository (e.g., git clone https://github. com/username/repository. git), which uses the git command to access a private repository. The instructions can also include authentication information, such as information provided in the user secrets that permit access to a private repository.

In some aspects, based on the cloned repository, the automated software development system can then retrieve packages and other content that can be built into a target of the repository. For example, the repository can include a package file (e.g., package. json) that identifies dependencies associated with the repository that are necessary to compile and build the target. The package file identifies a source of the package, and the automated software development system then retrieves and installs the packages as part of an install process (e.g., npm install, yarn install, pip install, cargo add, pnpm install, etc.). In some aspects, the installation of the packages can consume a significant volume of space (e.g., more than 1 GB is not uncommon) depending on the complexity of the build target, the framework, and other factors. In this case, the automated software development system is not instantaneous and is an asynchronous process. The target is also referred to a build target of the repository, such as an application in machine code, a web application, a library, etc.

At time t₄, the automated software development system is configured to disable the external network access by the container after the packages are successfully installed. The container is explicitly disabled for external network access to ensure a secure and deterministic execution context and prevent inbound or output network communication. The container may be configured to interface with a private network (e.g., that has no external network access) to allow the AI model to interact with the container. By preventing outbound or inbound external network communication, the automated software development system eliminates the risk of exfiltration of sensitive code, unauthorized access to external APIs, and/or attempts to hack external systems or other malicious actions. Once AI model modifies the data within the container, the environment is considered tainted and is no longer trusted for secure operations or data persistence. The isolation of the container prevents any malicious potential actions. For example, an attacker could embed a command to upload proprietary source code to an external server, fetch and execute a remote payload, or scan internal network resources. By disabling the network interface, the container becomes effectively sandboxed, prevents exploits, and reinforces the integrity and confidentiality of the development environment.

After disabling the external network access, an AI model (e.g., an LLM of the generative response engine) is provided access after the network to the container is disabled. The access can be provided in multiple ways, such as having the container itself query the generative response engine. In other cases, a command can be issued to cause the AI model to connect to an interface (e.g., a network port) of a network server that allows the AI model to access one or more interfaces. Non-limiting examples of interfaces include a terminal that is configured for the AI model, a server to issue API commands to modify files, etc.

At time t₅, the AI model is configured to access the container and interact with the various services (e.g., entry points) to access and edit the repository. For example, the AI model may interact with an API to make changes to the files (e.g., generate new instructions, remove instructions, etc.). In other aspects, the AI model can also access a terminal to interface with various aspects of the system, such as running unit tests, compiling the code, etc. The AI model may generate data associated with the task such as by capturing its inner monologue (e.g., chain-of-thought), input and output of the terminal emulator or the terminal log, and any changes to any file within the container.

In some aspects, the AI model may be a pruned version of a larger AI model and is specifically reduced to focus on code generation and other tasks associated with a developer. A pruned machine learning model for software development tasks is created by removing parameters or layers that contribute minimally to the model's output, based on metrics such as weight magnitude, activation sparsity, or gradient sensitivity. For example, a fully trained model is then analyzed to identify redundant or low-importance components that can be eliminated without significantly degrading performance. These components are pruned to result in a smaller model that may be fine-tuned to recover any lost accuracy. The pruned model uses reduced computational and memory footprint, less power consumption, and faster inference times.

At time t₆, a back end service is configured to extract the data associated with the software development task (e.g., the inner monologue, the terminal log, and any changes to any file within the container). In one example, a container service that spawns and controls the container can be configured to execute commands through the container. For example, the container service can execute an application in the container that generates a diff (e.g., a git diff) and retrieves other data stored in the container. In other cases, the container can be accessed via other services, such as a network file system or other mechanism to allow internal network access to retrieve the contents created by the AI model. In some aspects, a server can be installed in the container that provides access to retrieve files can be configured in the container.

At time t₇, the container is configured to stop. For example, a signal is sent to the server in the container that causes a task to exit, thereby exiting the entry point of the container and forcing the container to stop operation.

The automated software development environment is a secure, container-based system that leverages a generative machine learning model to perform tasks such as code generation, repository analysis, and software modification. Upon receiving instructions from a client, the system provisions an isolated and dedicated container that is dynamically configured using user-specific startup scripts, secrets, and environment settings. The container is initialized with the necessary development tools and dependencies, including package managers and repository files. External network access is disabled to ensure security, prevent data exfiltration, and isolate the container from malicious activity. This architecture ensures strong isolation and security by disabling external network access, supports dynamic and user-specific configuration without modifying the base image, and enables scalable, asynchronous execution of software development tasks.

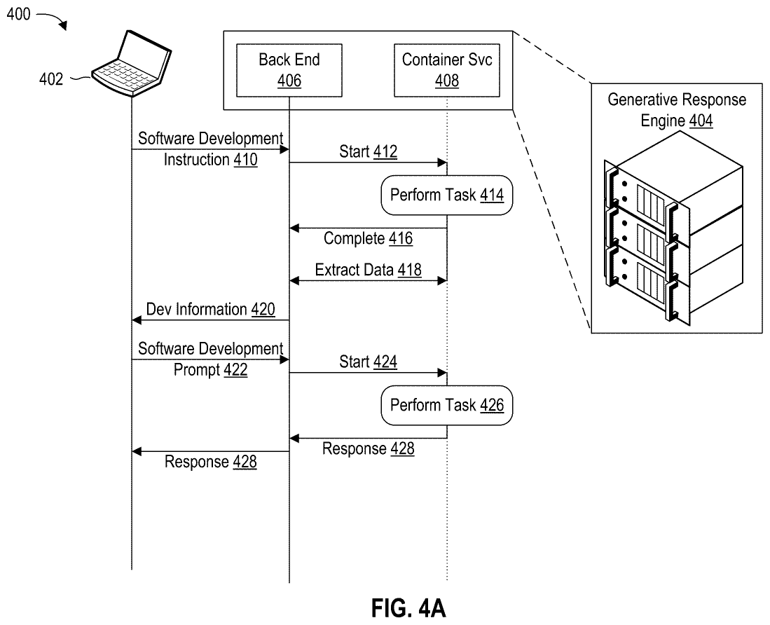

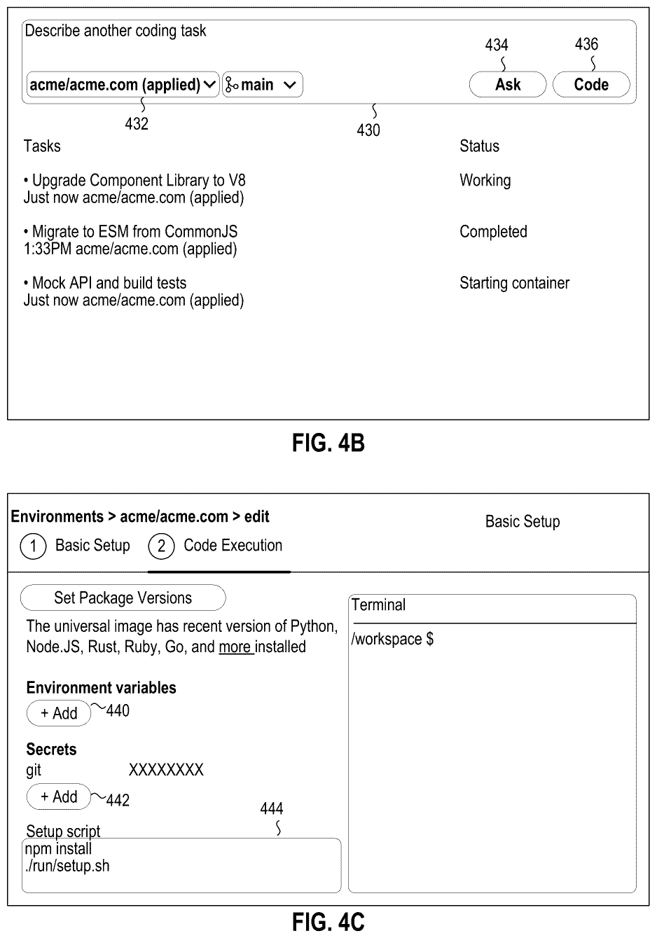

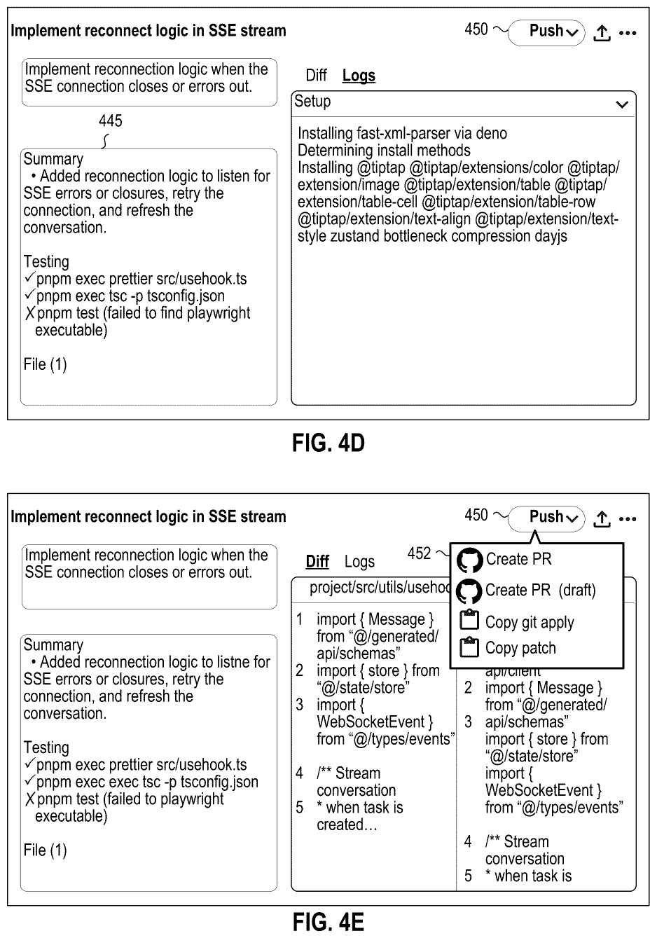

FIG. 4A is a sequence diagram illustrating different modes of a software development task using a generative response engine in accordance with some aspects of the disclosure. In some aspects, the automated software development system 400 includes client device 402 and generative response engine 404. The generative response engine 404 uses a back end 406 and a container service 408 to interact and perform software development tasks. In some aspects, the container service 408 may use a container application (e.g., docker) to create, manage, and orchestrate containerized workloads on demand. For example, the container service 408 is configured to interact with running containers by executing commands inside them using docker exec functionality, allowing retrieve real-time output from containers to enable dynamic inspection, debugging, or data extraction.

In some aspects, the client device 402 (e.g., the front end 102) sends a software development instruction 410. The software development instruction 410 includes an identification of a repository, either public or private, and a natural language task that describes the software development functions to perform (e.g., write code, build a unit test, debug a function, generate data models, etc.). The back end 406 receives the software development instruction 410 and then sends a start command to a container service 408. The container service 408 may be a cloud-based collection of services in a data center and can dynamically allocate containers for various functions. The container service 408 is configured to start a container based on various information (e.g., a user startup script, user secrets, clone repository, etc.) and perform the task outlined in the software development instruction 410 at block 414. Once completed the container service 408 may send a completion signal to the back end 406, which triggers the back end 406 to extract data 418 associated with the software development task (e.g., execute a git diff). In one example, the back end 406 may generate the development information 420 by combining the extracted data 418 with information stored by services (e.g., the inner monologue, the terminal log, and any changes to any file within the container) associated with the software development task. In some aspects, the container service 408 corresponds to an internal interface and does not use an network interface to access the container.

The development information 420 is sent to the client device 402 to provide a graphical view of the task performed by the AI model. For example, the development information 420 can include a summary view that illustrates operations performed (e.g., based on the terminal log), a diff illustrating various changes to a cloned repository, etc. In this way, the client device 402 is configured to display information that allows human review before merging the code into the cloned repository itself (e.g. via a git pull request).

In some aspects, the client device 402 may also be able to send other various types of instructions which can have different execution cycles. For example, the user may send a natural language request requesting information about the changes (e.g., an ask mode) of the previous task.

For example, the client device may send a software development prompt 422 to the container service 408 requesting additional information about the development information 420. The back end 406 may send a start command 424 which includes the software development prompt 422 to the container service 408. In some aspects, the container service 408 starts a container, but in this case only retrieves information necessary for the software development prompt 422. For example, the container service 408 may access a database to retrieve the development information 420 from the previous task (e.g., the software development instruction 410) and any necessary context such as the original repository, and then generate a response. The container provides access to the AI model and generates a response 428, which is conveyed to the client device 402. In this case, the container service 408 does not have to retrieve the full repository to build the target, which may reduce the time to perform the task since large volumes of network data can be omitted as part of the container startup process.

Other types of modes are possible. For example, the automated software development system 400 can include modes for generating synthetic data for unit tests, debugging, user interface design, and so forth.

FIGS. 4B-4E illustrate various screens and conceptual diagrams of an automated software development system using a generative response engine in accordance with some aspects of the disclosure.

FIG. 4B illustrates a primary user interface of the automated software development system. In some aspects, the user interface includes a text input 430 for receiving a natural language task from a user. The text input also includes a selectable item 432 or other user control for selecting an associated repository and a branch of that repository (e.g., main). The natural language task can be executed in different modes based on a button input, such as the code button 434 and an ask button 436. As described above, there are different types of tasks that have different execution requirements and different buttons are a simple and intuitive manner for executing different modes when there are a small number of different options. The primary user interface is capable of spawning a new container for a task once a button is input without navigating the view, but dynamically updating the task list. In such a case, this user interface allows a user to spawn multiple tasks to create an autonomous team of developers.

FIG. 4C illustrates a user interface for generating user startup information. For example, the user interface allows the creation of environment variables within the container via a button 440 which can add key/value pairs. The user interface also allows the creation of user secrets via button 442, which can add key/value pairs. The values associated with the secrets can be double encrypted in a vault to protect from leakage. The user interface also includes a text input 444 for the user to customize the startup script.

FIG. 4D illustrates a user interface illustrating a view of the software development task after completion, which allows a user to generate change proposals for propagating the changes developed within the container to external sources with minimal friction (e.g., a git pull request). For example, the user interface includes a button 450 for generating a change proposal. The user interface also displays a summary of the tasks performed, completed, and any failed tests that the generative response engine executed (e.g., via a terminal emulator). In some aspects, the software development task also includes a log that illustrates commands that are executed in the container to allow a developer to audit the events, allowing the developer to act as a supervisor and validate the task.

FIG. 4E illustrates the user interface options to generate change proposals. In this case, a button 450 can be invoked to display different options 452 to generate a change proposal (e.g., a PR, a git apply, or a manual patch). In some aspects, the PR is a collaborative feature commonly used on platforms like GITHUB or GITLAB to allow developers to propose changes from one branch to another while enabling code review, comments, CI integration, and approval workflows. The PR includes full commit metadata and is ideal for team-based development. The git apply is a command-line tool used to apply patch files that are typically generated with git diff directly to the working tree without committing. The git apply option is lightweight and useful for sharing changes without using a remote repository, but lacks commit history and metadata unless manually added. A manual patch uses generic diff tools like diff and patch to apply changes and requires careful handling because it doesn't track repository state or resolve conflicts automatically.

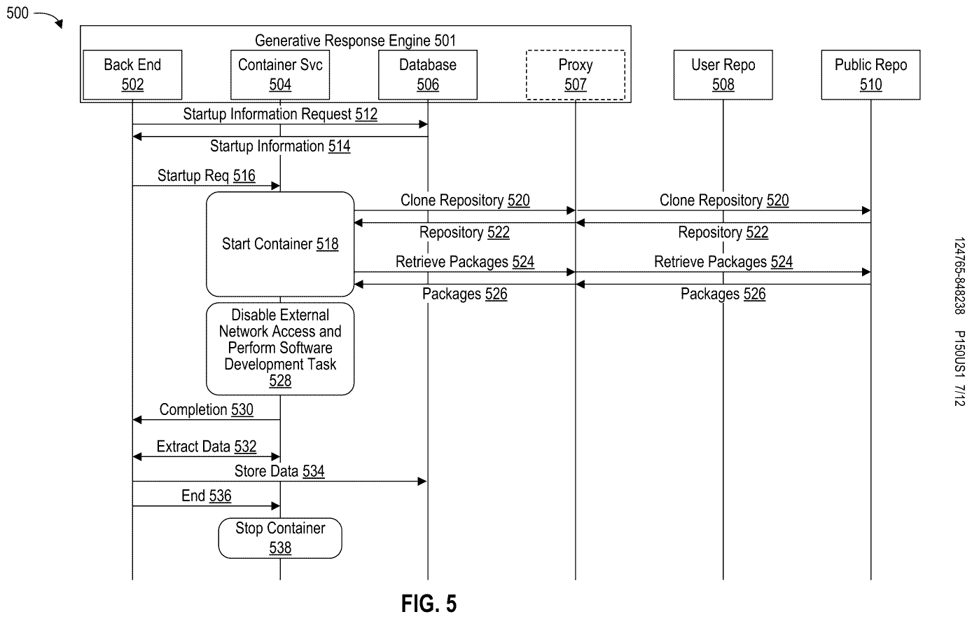

FIG. 5 is a sequence diagram illustrating various operations of a container of an automated software development system 500 in accordance with some aspects of the disclosure. In some aspects, automated software development system 500 illustrates operations at back end 502, container service 504 and a database 506 of a generative response engine 501. As described further below, generative response engine 501 is configured to access a user repository 508 and a public repository for building the target.

Back end 502 initially sends startup information request 512 to database 506 to receive execution information and user information. For example, database 506 may store profile information including user secrets (e.g., authentication information for user repository 508), custom startup scripts, etc.) that can be added to a system startup script. Database 506 returns startup information 514 to back end 502 for updating the container service. Back end 502 then executes startup request 516 (e.g., docker run) to start the container at block 518.

In some aspects, the container uses the startup information to send a clone repository command 520 (e.g., git clone) to user repository 508, which returns repository 522. In some aspects, repository 522 includes packages and sources of information for building the target of user repository 508 (e.g., an application, a library, etc.). In some cases, the packages can include additional git repositories, as well as public package repositories. The container then executes a corresponding command to send a package request 524 and retrieve packages 526. In some cases, packages 526 can be quite large and this process can take seconds to minutes, depending on the repository complexity and language (e.g., JavaScript tends to be larger than bytecode).

For example, Table 4 below illustrates an example start script that accesses a user's git repository (e.g., git clone), retrieves user script (e.g., dynamodb git-item), retrieves dependencies associated with the user's repository.

```
TABLE 4
#!/usr/bin/env bash
set −euo pipefail
echo “[1/7] Cloning private repo...”
# embed credentials into URL (HTTPS); make sure this token is only in env
git clone “https://${GIT_USER}:${GIT_TOKEN}@${REPO_URL#https://}”
/workspace/repo
echo “[2/7] Pull execution environment and user scripts, then execute
dynamodb get-item −−table-name USERTABLENAME \
  −−key ‘{“ScriptName”: {“S”: “userStartup”}}’ −−projection-expression
“ScriptContent”
exec ./userStartup.sh “$@”
echo “[3/7] Installing dependencies...”
cd /workspace/repo
if [ −f requirements.txt ]; then
  pip install −−no-cache-dir −r requirements.txt
elif [ −f package. json ]; then
  npm ci
elif [ −f build.gradle ] ∥ [ −f pom.xml ]; then
  # add your build tool here
  ./gradlew build −−no-daemon
else
  echo “No recognized dependency file-skipping install.”
fi
# 4. Cut off external network access
echo “[4/7] Cutting off external network access...”
# Default policy DROP
iptables −P OUTPUT DROP
iptables −P INPUT DROP
iptables −P FORWARD DROP
# Allow localhost so services inside container can still talk
iptables −A OUTPUT −o lo −j ACCEPT
iptables −A INPUT −i lo −j ACCEPT
echo “[5/7] Cleaning up secrets...”
unset GIT_TOKEN GIT_USER AWS_ACCESS_KEY_ID AWS_SECRET_ACCESS_KEY
rm −f “${HOME}/. ssh/”* # Remove any SSH keys if mounted
echo “[6/7] Launching LLM terminal emulator (LLMte)...”
# Gotty must be installed in image; serves an LLM chunk stream over web socket
nohup LLMte −−permit-write −−reconnect −−once \
  −−port 8081 −−title-format “{{.ClientAddr}} − {{.Command}}” \
  zsh &> /var/log/terminal-service.log &
echo “[7/7] Starting orchestration-status API on port 8080...”
nohup python3 − <<‘PYCODE’ &> /var/log/orchestration-server.log &
import os
from flask import Flask, jsonify
app = Flask(_{——}name_{——})
@app.route(“/status”)
def status( ):
    # orchestration engine can touch /workspace/repo/done.flag
    done = os.path.exists(“/workspace/repo/done.flag”)
    return jsonify(done=done)
if _{——}name_{——} == “_{——}main_{——}”:
    app.run(host=“0.0.0.0”, port=8080)
PYCODE
echo “Entry point complete. Services running.”
# keep container alive
wait
```

At block 528, the container disables the external network access and the AI model (e.g., a processing device configured for high volume parallel floating point operations) begins performing the software development task. For example, in the example in Table 3, the IPtables prevent external network traffic. Other types of configurations can configure the network, such as disabling a virtual network connection in the container and enabling a virtual network connection that cannot access external network addresses.

In some aspects, as an alternative to disabling the external network access, the container may use a proxy 507 of generative response engine 501 to selectively control external network access based on software development task state. For example, proxy 507 may be configured via back end 502 to limit network access in some cases. For example, a software development task may be associated with a specific API, and back end 502 may configure the proxy 507 to allow the container to connect to a domain associated with the API to develop network requests (e.g., HTTP verb commands such as get, post, etc.). In other cases, proxy 507 may allow interaction with other package repositories, API surfaces, and so forth. Proxy 507 can also completely block network connections.

Once the AI model is complete, the container is configured to send a completion signal 530 to the back end 502. For example, an orchestration engine (e.g., the orchestration engine 222) receives the signal and then retrieves or extracts the data from the container at block 532 (e.g., the inner monologue, the terminal log, and any changes to any file within the container). In one example, an internal interface (e.g., via a container service) can execute a docker command (e.g., docker exec) to invoke the container to provide a git diff that includes all changes to the code of the repository. In other cases, the container may include additional services, such as a network file system configured for read access, to configure an internal interface to the container for retrieving data. Back end 502 also stores the extracted information from the container in database 506 because the container is ephemeral and once stopped, is unavailable. After the data is stored, Back end 502 sends an end signal to the container, which stops the container at block 538.

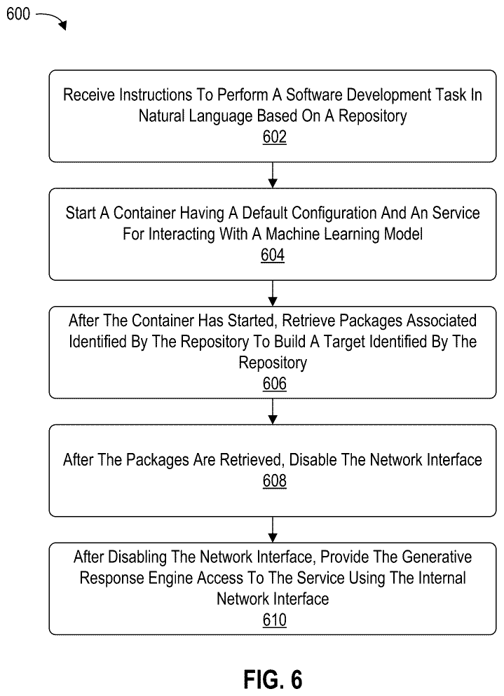

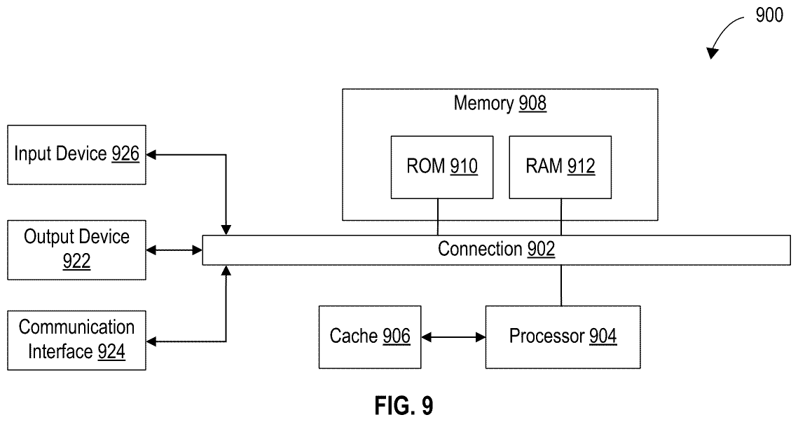

FIG. 6 illustrates a flowchart of process for executing a software development task in an isolated environment using a generative response engine in accordance with some aspects of the disclosure. Process 600 (or any other described herein) can be performed by a computing device (or apparatus) or a component (e.g., one or more chipsets, a SoC, one or more processors such as one or more CPUs, GPUs, DSPs, NPUs, NSPs, microcontrollers, ASICs, FPGAs, programmable logic devices, discrete gates or transistor logic components, discrete hardware components, etc., an ML system such as a neural network model, any combination thereof, and/or other component or system) of the computing device. The operations of process 600 may be implemented as software components that are executed and run on one or more processors (e.g., CPU, GPU, DSP, NPU or neural engine, SoC, processor 904 of FIG. 9, and/or other processor(s)).

In some aspects, the computing system may receive the instructions to perform a software development task and spawn a container based on an execution environment identified by a user configuration. The container process can include a startup configuration which can include retrieving packages associated with a development environment associated with a repository (e.g., code repository 254). For example, the repository may be specified by a user (e.g., a GitHub repo).

At block 602, the computing device is configured to receive instructions to perform a software development task in natural language based on a repository. For example, the repository can be stored in a public or private repository and includes various definitions such as packages to build a target. In some cases, a target is an application that can be executed independently on machine, bytecode, or can be an interpretable code (e.g., a JavaScript bundle). In some cases, the target can be combination of targets (e.g., a Rust-based application structure composed over JavaScript webview framework).

At block 604, the computing device is configured to start a container having a default configuration. In some aspects, the container includes an agent for interacting with generative response engine (e.g., an AI model such as an LLM, etc.) via an internal network interface and an external network interface for accessing the public network.

In some aspects, the starting process includes various blocks and additional operations described below. For example, the computing device may execute a system startup script associated with a system configuration, and the system start script includes an instruction to execute a user startup script defined by a user. For example, the user startup script is merged (e.g., using a string interpolation) with the system startup script. The user startup script is executed before an instruction in the system startup script to disable the external network interface.

For example, the container is configured to start and may be injected with a startup script that is executed and includes a combination of system configuration and user configuration. For example, the starting process includes retrieving user secrets, decrypting user secrets, and cloning the repository using the external network interface in the container. The cloning of the repository can be via a public or private repository (e.g., using the user secrets).

At block 606, the computing device is configured to, after the container is started, retrieve packages associated identified by the repository to build a target identified by the repository. For example, in a JavaScript-based application (e.g., a web application, a cross platform application), the computing device may execute “npm install” to install all packages identified in the package. json file. The startup script can include additional instructions to install various packages, commands, libraries, validate data, etc.

At block 608, the computing device is configured to disable the external network interface, after the packages are retrieved. In some aspects, the external network interface can be disabled via software using commands (e.g., iptables) or the container itself may be configured to remove a virtual interface.

At block 610, the computing device is configured to, after disabling the external network interface, provide the generative response engine access to the agent using the internal network interface. In some aspects, the agent can be a terminal emulator that is configured to chunk input and output in a form that an AI model will understand. In this case, input and output may include line numbers, and content is duplicated. For example, a first line number may be “~/.ssh” indicating the path of the terminal and a second line may be “~/.ssh/touch file.txt” which indicates a difference identifying the AI model is executing a local command to create file. txt (via the touch command).

In some aspects, the computing device is configured to, in response to receiving an indication that the generative response engine has completed the software development task, retrieve data associated with the software development task. In one example, an internal interface (e.g., via a container service) can execute a docker command (e.g., docker exec) to invoke the container to provide a git diff. In other cases, the container may include additional services, such as a network file system configured for read access, to configure an internal interface to the container for retrieving data. For example, the container can be mounted based on the task being completed, and all information from the container that is relevant to the task (e.g., the terminal log structured in a manner for a generative response engine, code files, inner monologue, etc.) is extracted. After the data is extracted, the data is stored in a database. The container then shuts down.

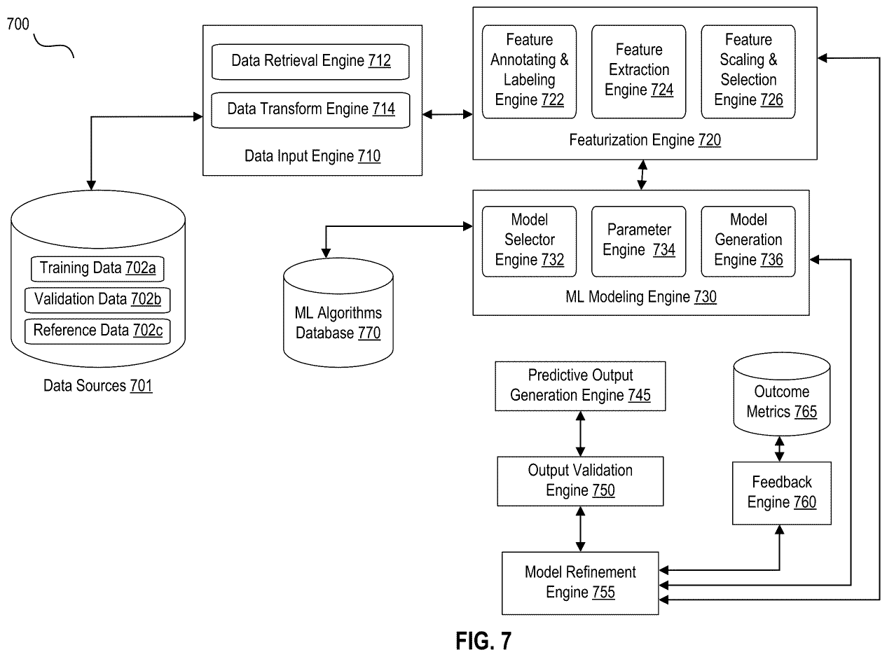

FIG. 7 is a block diagram illustrating an example machine learning platform for implementing various aspects of this disclosure in accordance with some aspects of the present technology. Although the example system depicts particular system components and an arrangement of such components, this depiction is to facilitate a discussion of the present technology and should not be considered limiting unless specified in the appended claims. For example, some components that are illustrated as separate can be combined with other components, and some components can be divided into separate components.

System 700 may include data input engine 710 that can further include data retrieval engine 712 and data transform engine 714. Data retrieval engine 712 may be configured to access, interpret, request, or receive data, which may be adjusted, reformatted, or changed (e.g., to be interpretable by another engine, such as data input engine 710). For example, data retrieval engine 712 may request data from a remote source using an API. Data input engine 710 may be configured to access, interpret, request, format, re-format, or receive input data from data sources(s) 701. For example, data input engine 710 may be configured to use data transform engine 714 to execute a re-configuration or other change to data, such as a data dimension reduction. In some aspects, data sources(s) 701 may be associated with a single entity (e.g., organization) or with multiple entities. Data sources(s) 701 may include one or more of training data 702a (e.g., input data to feed a machine learning model as part of one or more training processes), validation data 702b (e.g., data against which at least one processor may compare model output with, such as to determine model output quality), and/or reference data 702c. In some aspects, data input engine 710 can be implemented using at least one computing device. For example, data from data sources(s) 701 can be obtained through one or more I/O devices and/or network interfaces. Further, the data may be stored (e.g., during execution of one or more operations) in a suitable storage or system memory. Data input engine 710 may also be configured to interact with a data storage, which may be implemented on a computing device that stores data in storage or system memory.

System 700 may include featurization engine 720. Featurization engine 720 may include feature annotating & labeling engine 722 (e.g., configured to annotate or label features from a model or data, which may be extracted by feature extraction engine 724), feature extraction engine 724 (e.g., configured to extract one or more features from a model or data), and/or feature scaling & selection engine 726 Feature scaling & selection engine 726 may be configured to determine, select, limit, constrain, concatenate, or define features (e.g., AI features) for use with AI models.

System 700 may also include ML modeling engine 730, which may be configured to execute one or more operations on a machine learning model (e.g., model training, model re-configuration, model validation, model testing), such as those described in the processes described herein. For example, ML modeling engine 730 may execute an operation to train a machine learning model, such as adding, removing, or modifying a model parameter. Training of a machine learning model may be supervised, semi-supervised, or unsupervised. In some aspects, training of a machine learning model may include multiple epochs, or passes of data (e.g., training data 702a) through a machine learning model process (e.g., a training process). In some aspects, different epochs may have different degrees of supervision (e.g., supervised, semi-supervised, or unsupervised). Data into a model to train the model may include input data (e.g., as described above) and/or data previously output from a model (e.g., forming a recursive learning feedback). A model parameter may include one or more of a seed value, a model node, a model layer, an algorithm, a function, a model connection (e.g., between other model parameters or between models), a model constraint, or any other digital component influencing the output of a model. A model connection may include or represent a relationship between model parameters and/or models, which may be dependent or interdependent, hierarchical, and/or static or dynamic. The combination and configuration of the model parameters and relationships between model parameters discussed herein are cognitively infeasible for the human mind to maintain or use. Without limiting the disclosed aspects in any way, a machine learning model may include millions, billions, or even trillions of model parameters. ML modeling engine 730 may include model selector engine 732 (e.g., configured to select a model from among a plurality of models, such as based on input data), parameter engine 734 (e.g., configured to add, remove, and/or change one or more parameters of a model), and/or model generation engine 736 (e.g., configured to generate one or more machine learning models, such as according to model input data, model output data, comparison data, and/or validation data).

In some aspects, model selector engine 732 may be configured to receive input and/or transmit output to ML algorithms database 770. Similarly, featurization engine 720 can utilize storage or system memory for storing data and can utilize one or more I/O devices or network interfaces for transmitting or receiving data. ML algorithms database 770 may store one or more machine learning models, any of which may be fully trained, partially trained, or untrained. A machine learning model may be or include, without limitation, one or more of (e.g., such as in the case of a metamodel) a statistical model, an algorithm, a neural network (NN), a convolutional neural network (CNN), a generative neural network (GNN), a Word2Vec model, a bag of words model, a term frequency-inverse document frequency (tf-idf) model, a GPT (Generative Pre-trained Transformer) model (or other autoregressive model), a diffusion model, a diffusion-transformer model, an encoder such as BERT (Bidirectional Encoder Representations from Transformers) or LXMERT (Learning Cross-Modality Encoder Representations from Transformers), a Proximal Policy Optimization (PPO) model, a nearest neighbor model (e.g., k nearest neighbor model), a linear regression model, a k-means clustering model, a Q-Learning model, a Temporal Difference (TD) model, a Deep Adversarial Network model, or any other type of model described further herein. Some of the ML algorithms in ML algorithms database 770 can be considered generative response engines. Generative response engines are those models are commonly referred to as Generative AI, and that can receive an input prompt and generate additional content based on the prompt. GPTs, diffusion models, and diffusion-transformer models are some non-limiting examples of generative response engines. Some specific examples of generative response engines that can be stored in the ML algorithms database 770 include versions DALL·E, CHAT GPT, and SORA, all provided by OPEN AI.

System 700 can further include predictive output generation engine 745 and output validation engine 750 (e.g., configured to apply validation data to machine learning model output). Predictive output generation engine 745 can analyze the input and identify relevant patterns and associations in the data it has learned to generate a sequence of words that predictive output generation engine 745 predicts is the most likely continuation of the input using one or more models from the ML algorithms database 770, aiming to provide a coherent and contextually relevant answer. Predictive output generation engine 745 generates responses by sampling from the probability distribution of possible words and sequences, guided by the patterns observed during its training. In some aspects, predictive output generation engine 745 can generate multiple possible responses before presenting the final one. Predictive output generation engine 745 can generate multiple responses based on the input, and these responses are variations that predictive output generation engine 745 considers potentially relevant and coherent. Output validation engine 750 can evaluate these generated responses based on certain criteria. These criteria can include relevance to the prompt, coherence, fluency, and sometimes adherence to specific guidelines or rules, depending on the application. Based on this evaluation, output validation engine 750 selects the most appropriate response. This selection is typically the one that scores highest on the set criteria, balancing factors like relevance, informativeness, and coherence.

System 700 can further include feedback engine 760 (e.g., configured to apply feedback from a user and/or machine to a model) and model refinement engine 755 (e.g., configured to update or re-configure a model). In some aspects, feedback engine 760 may receive input and/or transmit output (e.g., output from a trained, partially trained, or untrained model) to outcome metrics database 765. Outcome metrics database 765 may be configured to store output from one or more models and may also be configured to associate output with one or more models. In some aspects, outcome metrics database 765, or other device (e.g., model refinement engine 755 or feedback engine 760), may be configured to correlate output, detect trends in output data, and/or infer a change to input or model parameters to cause a particular model output or type of model output. In some aspects, model refinement engine 755 may receive output from predictive output generation engine 745 or output validation engine 750. In some aspects, model refinement engine 755 may transmit the received output to featurization engine 720 or ML modeling engine 730 in one or more iterative cycles.

The engines of system 700 may be packaged functional hardware units designed for use with other components or a part of a program that performs a particular function (e.g., of related functions). Any or each of these modules may be implemented using a computing device. In some aspects, the functionality of system 700 may be split across multiple computing devices to allow for distributed processing of the data, which may improve output speed and reduce computational load on individual devices. In some aspects, system 700 may use load-balancing to maintain stable resource load (e.g., processing load, memory load, or bandwidth load) across multiple computing devices and to reduce the risk of a computing device or connection becoming overloaded. In these or other aspects, the different components may communicate over one or more I/O devices and/or network interfaces.

System 700 can be related to different domains or fields of use. Descriptions of aspects related to specific domains, such as natural language processing or language modeling, is not intended to limit the disclosed aspects to those specific domains, and aspects consistent with the present disclosure can apply to any domain that utilizes predictive modeling based on available data.

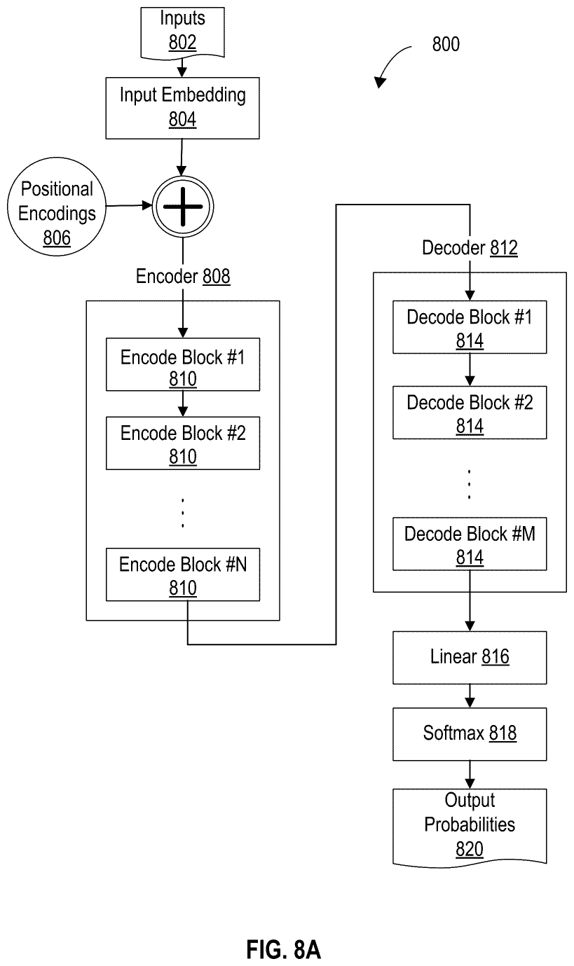

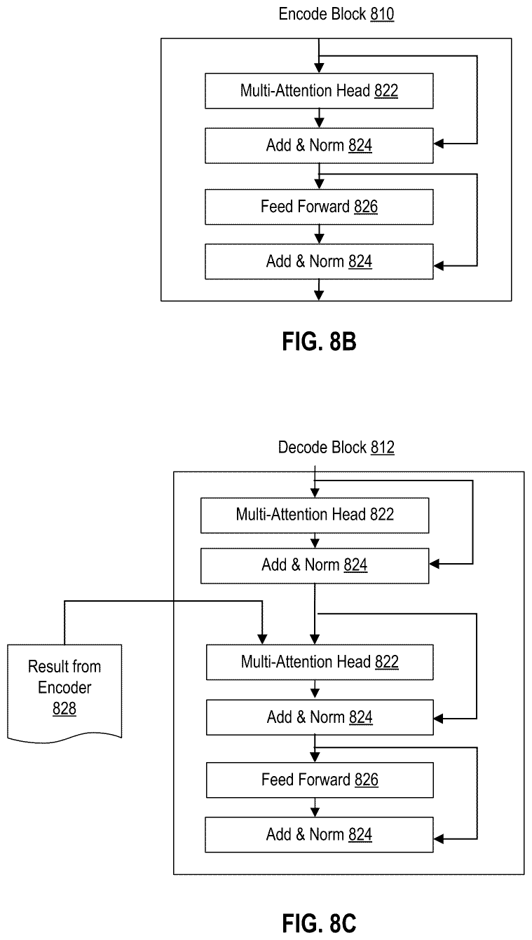

FIG. 8A, FIG. 8B, and FIG. 8C illustrates an example transformer architecture in accordance with some aspects of the present technology. Examples of ML models that use a transformer neural network (e.g., transformer architecture 800) can include, e.g., generative pretrained transformer (GPT) models and Bidirectional Encoder Representations from Transformer (BERT) models. The transformer architecture 800, which is illustrated in FIG. 8A, FIG. 8B, and FIG. 8C, includes inputs 802, input embedding block 804, positional encodings 806, encoder 808 including encode blocks 810, decoder 812 including decode blocks 814, linear block 816, softmax block 818, and output probabilities 820.

Input embedding block 804 is used to provide representations for words. For example, embedding can be used in text analysis. According to certain non-limiting examples, the representation is a real-valued vector that encodes the meaning of the word in such a way that words that are closer in the vector space are expected to be similar in meaning. Word embeddings can be obtained using language modeling and feature learning techniques, where words or phrases from the vocabulary are mapped to vectors of real numbers. According to certain non-limiting examples, the input embedding block 804 can be learned embeddings to convert the input tokens and output tokens to vectors of dimension that have the same dimension as the positional encodings, for example.

Positional encodings 806 provide information about the relative or absolute position of the tokens in the sequence. According to certain non-limiting examples, positional encodings 806 can be provided by adding positional encodings to the input embeddings at the inputs to the encoder 808 and decoder 812. The positional encodings have the same dimension as the embeddings, thereby enabling a summing of the embeddings with the positional encodings. There are several ways to realize the positional encodings, including learned and fixed. For example, sine and cosine functions having different frequencies can be used. That is, each dimension of the positional encoding corresponds to a sinusoid. Other techniques of conveying positional information can also be used, as would be understood by a person of ordinary skill in the art. For example, learned positional embeddings can instead be used to obtain similar results. An advantage of using sinusoidal positional encodings rather than learned positional encodings is that doing so allows the model to extrapolate to sequence lengths longer than the ones encountered during training.

Encoder 808 can use stacked self-attention and point-wise, fully connected layers. Encoder 808 can be a stack of N identical layers (e.g., N=6), and each layer can be an encode block, as illustrated by encode block 810 shown in FIG. 8B. Each encode block 810 has two sub-layers: (i) a first sub-layer has a multi-head attention block 822 and (ii) a second sub-layer has a feed forward block 826, which can be a position-wise fully connected feed-forward network. The feed forward block 826 can use a rectified linear unit (ReLU).

Encoder 808 uses a residual connection around each of the two sub-layers, followed by an add & norm block 824, which performs normalization. For example, the output of each sub-layer can be LayerNorm(x+ Sublayer(x)). To facilitate these residual connections, all sub-layers in the model, as well as the embedding layers, produce output data having a same dimension.

Similar to encoder 808, decoder 812 uses stacked self-attention and point-wise, fully connected layers. Decoder 812 can also be a stack of M identical layers (e.g., M=6), and each layer can be a decode block, as illustrated by decoder 812 shown in FIG. 8B. In addition to the two sub-layers (i.e., the sublayer with multi-head attention block 822 and the sub-layer with feed forward block 826) found in encode block 810, decode block 814 can include a third sub-layer, which performs multi-head attention over the output of the encoder stack. Similar to encoder 808, decoder 812 uses residual connections around each of the sub-layers, followed by layer normalization. Additionally, the sub-layer with multi-head attention block 822 can be modified in the decoder stack to prevent positions from attending to subsequent positions. This masking, combined with the fact that the output embeddings are offset by one position, can ensure that the predictions for position i can depend only on the known output data at positions less than i.

Linear block 816 can be a learned linear transformation. For example, when transformer architecture 800 is being used to translate from a first language into a second language, linear block 816 can project the output from the last decode softmax block 818 into word scores for the second language (e.g., a score value for each unique word in the target vocabulary) at each position in the sentence. For instance, if the output sentence has seven words and the provided vocabulary for the second language has 10,000 unique words, then 10,000 score values are generated for each of those seven words. The score values indicate the likelihood of occurrence for each word in the vocabulary in that position of the sentence.

Softmax block 818 then turns the scores from linear block 816 into output probabilities 820 (which add up to 1.0). In each position, the index provides for the word with the highest probability, and then maps that index to the corresponding word in the vocabulary. Those words then form the output sequence of transformer architecture 800. The softmax operation is applied to the output from linear block 816 to convert the raw numbers into output probabilities 820 (e.g., token probabilities).

FIG. 9 shows an example of computing system 900, which can be, for example, any computing device making up any engine illustrated in FIG. 1 or any component thereof.

In some aspects, computing system 900 is a single device, or a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

In some aspects, computing system 900 may comprise one or more computing resources provisioned from a “cloud computing” provider, For example, AMAZON ELASTIC COMPUTE CLOUD (“AMAZON EC2”), provided by AMAZON, INC. of Seattle, Washington; SUN CLOUD COMPUTER UTILITY, provided by SUN MICROSYSTEMS, INC. of Santa Clara, California; AZURE, provided by MICROSOFT CORPORATION of Redmond, Washington, GOOGLE CLOUD PLATFORM, provided by ALPHABET, INC. of Mountain View, California, and the like.

Example computing system 900 includes at least one processing unit (CPU or processor) 904 and connection 902 that couples various system components including system memory 908, such as read-only memory (ROM) 910 and random access memory (RAM) 912 to processor 904. Memory 908 can be a volatile or non-volatile memory device, and can be a hard disk or other types of non-transitory computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

Memory 908 can include software services, servers, logic, etc., that when the code that defines such software is executed by the processor 904, it causes the system to perform a function. In some aspects, a hardware service that performs a particular function can include the software component stored in a computer-readable medium in connection with the necessary hardware components, such as processor 904, connection 902, output device 922, etc., to carry out the function.

Computing system 900 can include a cache of high-speed memory 906 connected directly with, in close proximity to, or integrated as part of processor 904.

Connection 902 can be a physical connection via a bus, or a direct connection into processor 904, such as in a chipset architecture. Connection 902 can also be a virtual connection, networked connection, or logical connection.

Processor 904 can include any general purpose processor and a hardware service or software service stored in memory 908, configured to control processor 904 as well as a special-purpose processor where software instructions are incorporated into the actual processor design. Processor 904 may essentially be a completely self-contained computing system, containing multiple cores or processors, a bus, memory controller, cache, etc. A multi-core processor may be symmetric or asymmetric. Processor 904 can be physical or virtual.

To enable user interaction, computing system 900 includes an input device 926, which can represent any number of input mechanisms, such as a microphone for speech, a touch-sensitive screen for gesture or graphical input, keyboard, mouse, motion input, speech, etc. Computing system 900 can also include output device 922, which can be one or more of a number of output mechanisms known to those of skill in the art. In some instances, multimodal systems can enable a user to provide multiple types of input/output to communicate with computing system 900. Computing system 900 can include communication interface 924, which can generally govern and manage the user input and system output. There is no restriction on operating on any particular hardware arrangement, and therefore the basic features here may easily be substituted for improved hardware or firmware arrangements as they are developed.

In some aspects, computing system 900 can refer to a combination of a personal computing device interacting with components hosted in a data center, where both the computing device and the components in the data center. In such examples, both the personal computing device and the components in the datacenter might have a processor, cache, memory, storage, etc.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, For example, instructions and data which cause or otherwise configure a general purpose computer, special purpose computer, or special purpose processing device to perform a certain function or group of functions. Portions of computer resources used can be accessible over a network. The executable computer instructions may be, For example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

The present technology includes computer-readable storage mediums for storing instructions, and systems for executing any one of the methods embodied in the instructions addressed in the aspects of the present technology presented below:
Aspect 1. A method of automating software development, comprising: receiving instructions to perform a software development task in natural language based on a repository; starting a container having a default configuration, wherein the container includes an agent for interacting with a machine learning model via an internal network interface and an external network interface for accessing the public network; after the container is started, retrieving packages associated identified by the repository to build a target identified by the repository; and after the packages are retrieved, disabling the external network interface.
Aspect 2. The method of Aspect 1, further comprising: cloning the repository using the external network interface in the container.
Aspect 3. The method of Aspect 2, wherein retrieving the repository includes providing user defined secrets associated with the repository.
Aspect 4. The method of any of Aspects 1 to 3, further comprising: after disabling the external network interface, providing the generative response engine access to the agent using the internal network interface.
Aspect 5. The method of any of Aspects 1 to 4, further comprising: in response to receiving an indication that the generative response engine had completed the software development task, accessing the container and retrieving task summary including identification of changes the repository and a log associated with the software development task; and storing the task summary in a database.
Aspect 6. The method of any of Aspects 1 to 5, further comprising: executing a system startup script associated with a system configuration, wherein the system start script includes an instruction to execute a user startup script defined by a user.
Aspect 7. The method of any of Aspects 1 to 6, wherein the user startup script is executed before an instruction in the system startup script to disable the external network interface.
Aspect 8. A computing device for automating software development, comprising: at least one memory; and at least one processor coupled to the at least one memory and configured to: receive instructions to perform a software development task in natural language based on a repository; start a container having a default configuration, wherein the container includes an agent for interacting with a machine learning model via an internal network interface and an external network interface for accessing the public network; after the container is started, retrieve packages associated identified by the repository to build a target identified by the repository; and after the packages are retrieved, disable the external network interface.
Aspect 9. The computing device of Aspect 8, wherein the at least one processor is configured to: clone the repository using the external network interface in the container.
Aspect 10. The computing device of Aspect 9, wherein retrieving the repository includes providing user defined secrets associated with the repository.
Aspect 11. The computing device of any of Aspects 8 to 10, wherein the at least one processor is configured to: after disabling the external network interface, provide the generative response engine access to the agent using the internal network interface.
Aspect 12. The computing device of any of Aspects 8 to 11, wherein the at least one processor is configured to: in response to receiving an indication that the generative response engine had completed the software development task, access the container and retrieving task summary including identification of changes the repository and a log associated with the software development task; and store the task summary in a database.
Aspect 13. The computing device of any of Aspects 8 to 12, wherein the at least one processor is configured to: execute a system startup script associated with a system configuration, wherein the system start script includes an instruction to execute a user startup script defined by a user.
Aspect 14. The computing device of any of Aspects 8 to 13, wherein the user startup script is executed before an instruction in the system startup script to disable the external network interface.
Aspect 15. A non-transitory computer-readable medium storing instructions that, when executed by one or more processors, cause the processor to: receive instructions to perform a software development task in natural language based on a repository; start a container having a default configuration, wherein the container includes an agent for interacting with a machine learning model via an internal network interface and an external network interface for accessing the public network; after the container is started, retrieve packages associated identified by the repository to build a target identified by the repository; and after the packages are retrieved, disable the external network interface.
Aspect 16. The computer-readable medium of Aspect 15, wherein the processor is configured to execute the instructions and cause the processor to: clone the repository using the external network interface in the container.
Aspect 17. The computer-readable medium of Aspect 16, wherein retrieving the repository includes providing user defined secrets associated with the repository.
Aspect 18. The computer-readable medium of any of Aspects 15 to 17, wherein the processor is configured to execute the instructions and cause the processor to: after disabling the external network interface, provide the generative response engine access to the agent using the internal network interface.
Aspect 19. The computer-readable medium of any of Aspects 15 to 18, wherein the processor is configured to execute the instructions and cause the processor to: in response to receiving an indication that the generative response engine had completed the software development task, access the container and retrieving task summary including identification of changes the repository and a log associated with the software development task; and store the task summary in a database.
Aspect 20. The computer-readable medium of any of Aspects 15 to 19, wherein the processor is configured to execute the instructions and cause the processor to: execute a system startup script associated with a system configuration, wherein the system start script includes an instruction to execute a user startup script defined by a user.

What is claimed is:

1. A method comprising:
starting a container that will be used to support an agentic software development task related to packages in a repository, wherein the container includes a service for interacting with an AI model via an internal interface and an network interface for accessing a public network;
after the container has started, retrieving the packages identified by the repository to build a build target identified by the repository; and
after the packages are retrieved, disabling the network interface.

2. The method of claim 1, further comprising:
cloning the repository by downloading the packages in the repository using the network interface in the container.

3. The method of claim 2, wherein retrieving the repository includes providing user defined secrets associated with the repository.

4. The method of claim 1, further comprising:
after disabling the network interface, providing the AI model access to the service of the container using the internal interface.

5. The method of claim 1, further comprising:
in response to receiving an indication that a generative response engine had completed the agentic software development task, retrieving a task summary including identification of changes to the repository and a log associated with the agentic software development task; and
storing the task summary in a database.

6. The method of claim 1, further comprising:
executing a system startup script associated with a system configuration, wherein the system startup script includes user instructions defined by a user.

7. The method of claim 6, wherein the user instructions are executed before an instruction in the system startup script to disable the network interface or limit access by the network interface.

8. A computing device for automating software development, comprising:
at least one memory; and
at least one processor coupled to the at least one memory and configured to:
receive instructions to perform a software development task in natural language based on a repository;
start a container having a default configuration, wherein the container includes a service for interacting with a machine learning model via an internal interface and an network interface for accessing a public network;
after the container has started, retrieve packages associated identified by the repository to build a build target identified by the repository; and
after the packages are retrieved, disable the network interface.

9. The computing device of claim 8, wherein the at least one processor is configured to: clone the repository using the network interface in the container.

10. The computing device of claim 9, wherein retrieving the repository includes providing user defined secrets associated with the repository.

11. The computing device of claim 8, wherein the at least one processor is configured to:
after disabling the network interface, provide a generative response engine access to the service using the internal interface.

12. The computing device of claim 8, wherein the at least one processor is configured to:
in response to receiving an indication that a generative response engine had completed the software development task, access the container and retrieving task summary including identification of changes the repository and a log associated with the software development task; and
store the task summary in a database.

13. The computing device of claim 8, wherein the at least one processor is configured to:
execute a system startup script associated with a system configuration, wherein the system startup script includes user instructions defined by a user.

14. The computing device of claim 13, wherein the user instructions are executed before an instruction in the system startup script to disable the network interface or limit access by the network interface.

15. A non-transitory computer-readable medium storing instructions that, when executed by one or more processors, cause the one or more processors to:
receive instructions to perform a software development task in natural language based on a repository;
start a container having a default configuration, wherein the container includes an agent for interacting with a machine learning model via an internal interface and an network interface for accessing a public network;
after the container is started, retrieve packages associated identified by the repository to build a build target identified by the repository; and
after the packages are retrieved, disable the network interface.

16. The computer-readable medium of claim 15, wherein the one or more processors are configured to execute the instructions and cause the one or more processors to:
clone the repository using the network interface in the container.

17. The computer-readable medium of claim 16, wherein retrieving the repository includes providing user defined secrets associated with the repository.

18. The computer-readable medium of claim 15, wherein the one or more processors are configured to execute the instructions and cause the one or more processors to:
after disabling the network interface, provide a generative response engine access to the agent using the internal interface.

19. The computer-readable medium of claim 15, wherein the one or more processors are configured to execute the instructions and cause the one or more processors to:
in response to receiving an indication that a generative response engine had completed the software development task, access the container and retrieving task summary including identification of changes the repository and a log associated with the software development task; and
store the task summary in a database.

20. The computer-readable medium of claim 15, wherein the one or more processors are configured to execute the instructions and cause the one or more processors to:
execute a system startup script associated with a system configuration, wherein the system startup script includes user instructions defined by a user that are executed before an instruction to disable the network interface or limit access by the network interface.
